(19) United States
(12) Patent Application Publication
(10) Pub. No.: US 2012/0040217 A1
(43) Pub. Date: Feb. 16, 2012

(54) HOLDING ELEMENT FOR BATTERY CASE

(75) Inventors: Peter Kritzer, Forst (DE); Olaf Nahrwold, Ludwigshafen (DE); Markus Clemens, Reichelsheim (DE); Hans Unger, Abtsteinach (DE); Thomas Kramer, Rimbach (DE); Ingo Stephan, Rimbach (DE)

(73) Assignee: CARL FREUDENBERG KG, Weinheim (DE)

(21) Appl. No.: 13/023,587

(22) Filed: Feb. 9, 2011

(30) Foreign Application Priority Data
Aug. 11, 2010 (DE) 10 2010 034 059.6

(51) Int. Cl. H01M 2/12

(52) U.S. Cl. 429/82

(57) ABSTRACT

A closing element for closing an opening (3) of a battery housing (1), including a cover (5), whereby the cover (5) comprises a connection groove (6) into which groove a wall (13) of a battery housing (1) can be inserted, whereby a connection piece (7) that can be deformed without destruction projects from the cover (5) and whereby the connection piece (7) is provided with a nipple (8). The closing element solves the problem of designing and further developing a battery housing in such a manner that it has a reliable tightness in normal operation but in abnormal occurrences it allows gases to escape without problems and in a directed manner without parts of the battery housing or of a valve being slung away in an uncontrolled manner.

### TECHNICAL AREA

The present invention relates to a closing element for closing an opening of an electrochemical storage reservoir, in particular of a battery housing.

### STATE OF THE ART

Large-sized battery systems and/or other electrochemical storage reservoirs such as, for example, supercondensers are used in more and more applications. They are used, for example, in electric vehicles or hybrid vehicles, in industrial traction systems such a fork lift trucks or robots, in industrial trucks as well as in sport vehicles and recreational vehicles. Further usages are found in trains and airplanes.

In all these usages the batteries consist as a rule of a plurality of individual cells housed in a battery housing. Typical voltages of energy storage reservoirs used in this manner are up to 1000 V. Current strengths of more than 100 A are possible.

Typical lengths and widths of the battery housings are 500 mm×800 mm. The wall thicknesses of the battery housings are typically 1 to 5 mm. The battery housings are manufactured from metals, in particular steel or aluminum or from plastics, especially polyamide.

In case of an internal short circuit a development of gas can take place inside an individual cell. Typical volumes being released in a 40 Ah lithium cell are in a range of 100 L. The released gas, which consists of an electrolyte or electrolyte degradation products, is combustible and toxic.

Typically, cells open in a flexible coffee-bag design at internal pressures below 1 bar and cells with a solid, metallic casing with a cylindrical or prismatic design open at pressures of more than 10 bar.

The released gas then passes into the battery housing, where it results in a pressure rise which is a function of the dead volume in the battery housing. Furthermore, the pressure rise is a function of a possibility of a pressure loss due to leaks, for example, in the housing seal, to a transfer of the gas through pressure compensation openings that are applied in order to regulate the internal pressure of the battery in the normal state as well as to the type of cells or the rapidity of a cell opening.

During the sudden release of gases the battery housing can burst. At a dead volume of 20 L and release of 100 L gas the battery housing would be at an excess pressure of 5 bar. The combustible and toxic gas can come in contact with persons and can pass into the inner cabin of a vehicle. The combustible and toxic gas can come in contact with current-conducting parts, which can result in an ignition or an explosion.

As a rule, the released gases are not particularly hot, so that materials of NBR or EPDM can resist the gases. In addition, upon a release of gases the seal no longer plays a part, since a valve must open. Often, there is a requirement for valves and their components for a temperature resistance of more than 500° C. and for a resistance to hydrofluoric acid.

These temperature conditions can occur in burning batteries. The normally released, relatively low amounts of hydrofluoric acid concentrations can be tolerated when using polyolefinic elastomers such as EPDM. In order to avoid extremely critical states of the entire system in the case of the cited opening of a cell each large-size battery, especially a lithium battery, must therefore have an apparatus for the safe degradation of excess pressures.

A valve for the degradation of excess pressures should not open during normal operating states. For example, pressure differences due to temperature compensation or pressure differences when travelling in mountains and valleys should not result in an opening of the valve. These typical pressure fluctuations are in a range of max. +/−0.2 bar. Moreover, a valve must prevent in any case that water can penetrate from the outside.

Therefore, especially in automobile usages elevated requirements are placed on the valve. As a rule a stream-crossing ability must be present. A tightness must be present in car-wash systems or in the case of water sprayed under high pressure. As a rule, the protective type IP 67 (“protection against water” according to DIN EN 60529 and DIN 40050 part 9) is required here.

Furthermore, it must be prevented that parts fly around upon the opening of the valve. Therefore, in the case of an opening a moderate degradation of the excess pressure should take place. This means that an opening of valve should not take place suddenly but that the excess pressure is nevertheless degraded promptly. The entire system should be robust. It should be guaranteed that it still functions even after 10 years under “car conditions”.

Therefore, the valve should not display any aging and should not cake together upon contamination and corrosion. Typical free cross-sectional surfaces of the valve are a function of the capacity of the cells and the size of the battery. Typical cross-sectional surfaces are 5 cm² to 30 cm².

In order to solve the cited problems the battery housings of large-format lithium batteries as a rule contain a unit for degrading excess pressure. There are many designs for this.

A valve is conceivable that is controlled in conjunction with an internal pressure sensor. This has the disadvantage that this design is technically complicated and expensive, requires current, is susceptible to corrosion and is technically too complex. The principle of a rupture disc can also be used. For this, for example, thermoplastic foils are applied on openings of the battery housing. This has the disadvantage that the material can become brittle, resulting in a failure. No moderate pressure degradation is possible since a rupture disk bursts. A foil is susceptible to outer puncturing and/or injury. Furthermore, a spring valve can be used. This has the disadvantage that flying parts can not be excluded, that the spring is susceptible to corrosion and that the cross-sectional surface is limited.

### PRESENTATION OF THE INVENTION

The invention therefore has the basic problem of designing and further developing a battery housing in such a manner that it has a reliable seal in normal operation but allows gases to escape in a directed manner without problems in abnormal occurrences without parts of the battery housing or of a valve being thrown off in an uncontrolled manner.

The present invention solves the previously cited problem with the features of claim 1.

According to the invention a closing element for closing an opening of a battery housing comprises a cover, whereby the cover comprises a connection groove into which groove a wall of a battery housing can be inserted or snapped in, whereby a connection piece that can be deformed without destruction projects from the cover and whereby the connection piece is provided with a nipple. According to the invention this teaching indicates a simple, currentless and ageing-resistant embodiment of a closing element.

It was concretely recognized that a cover that is firmly connected on one side by a nipple to the battery housing is connected to this battery housing in such a manner that it is secure against being lost. The cover is connected to the nipple by a connection piece. This advantageously maintains the holding pressures constant for the period of the service life so that no weakening due to aging occurs.

If the cover jumps out, this is an indication of an emergency operation developed by the cover. The statement of the invention surprisingly succeeds in creating an aging-resistant, reliable closing element. This closing element indicates damage to or activity of a valve. The cover is fixed to the battery housing and cannot be thrown through the air when gas exits from the battery housing. To this extent a battery housing is indicated that has a reliable seal during normal operation but allows gases to escape in a directed manner without problems in problematic cases without parts of the battery housing being thrown off in an uncontrolled manner.

Consequently, the initially cited problem is solved.

The cover could comprise a circumferential seal for resting on the outer wall of the battery housing. The seal can offer a tightness against any water present coming from the outside. The water can optionally contain wetting agents like those occurring in cleaning agents in a carwash system. The seal should offer a tightness against sprayed oil. Furthermore, the seal should offer a tolerance compensation of the material of the cover relative to the battery housing. A compensation function is also desired that takes into account different coefficients of thermal expansion. The seal could consist of a solid elastomeric material or of a 2K structural component. The seal could be designed as a vulcanized-on elastomer. The seal could also be designed as an elastomer applied with a bead application process. The seal could be designed as an extruded, thermoplastic elastomer (TPE) or as thermoplastic polyurethane (TPU). The seal could be designed as adhered-on elastomer or TPE. The seal could be designed as closed-pore foam.

The connection groove could form different projections on the side facing the inner wall of the battery housing. This constitutes an eccentric alignment of the connection grove relative to the seal of the cover. This has the result that upon excess pressure inside the battery housing the cover opens at first on one side and thus a moderate pressure degradation takes place.

Given this background, a projection that is closer to the nipple could be larger than a projection that is at a distance from the nipple. The cover can then be pressed out of the wall in such a manner that the part of the connection groove closest to the nipple is pressed out of the wall last.

An area of the cover could enclose an angle with a plane parallel to the inner wall of the battery housing. As a result of the obliquity the cover has a greater stiffness in one area than in another area. Therefore, the deformation of the cover is more pronounced in one area than in another area.

Given this background, an area of the cover could enclose an angle X with a plane parallel to the inner wall of the battery housing which angle X is in the range of 2°<X<30°. This angle area proved to be especially advantageous for favorably forming a cover from an elastomer.

The nipple could be provided with an assembly aid that is set on it in such a manner that it can be removed or torn off. As a result, the nipple can be readily introduced into an opening.

A housing, in particular a battery housing with a first opening, could receive a cover of a closing element of the type described here in the first opening, and the nipple is received in a second opening. This ensures that the cover is not slung away through space if it bursts out of the wall of the housing.

A slot could be formed between the wall in which the first opening is formed and between a groove bottom of the cover. The slot prevents a caking of the elastomer to the battery housing. In addition, after a fairly long time a desired settling of the seal occurs, so that the slot retains its width or even becomes slightly larger. This ensures that a reliable opening can take place even after a long service life of the closing element.

The closing element of the type described here could be used to close a housing of an electrochemical storage reservoir, in particular of a battery housing.

Furthermore, it is conceivable to use the closing element in a chemical reactor in which a pressure rise can take place in an abnormal occurrence.

The cover or the closing element could be manufactured from elastomeric material or from a 2K structural component. The cover could be tightened in the housing. The cover could be tightened in such a manner that even after years of use no adhesion to the housing occurs (Stephan caverns). The cover could be constructed in such a manner that the opening takes place more readily on one side than on another side. This creates a “theoretical open mechanism”. The cover could be clamped to the housing in such a manner that different housing wall thicknesses can be tolerated.

The nipple could be manufactured from an elastomer. The nipple could be introduced in such a manner that it can not be torn out along with the cover flying away. To this end it could be introduced from the inside. The insertion directions of the cover and of the nipple could be aligned in the same direction or counter to one another. A part of the nipple could be removable. This would made possible a reduction of the construction space and a comfortable assembly.

The connection piece could consist of an elastomer, a fabric vulcanized in on the ends or of string. The cover, nipple and connection piece could be designed in one piece.

A tube or a hose could be provided on the closing element, by means of which tube or hose the gas can be securely removed. The hose could be inserted on or screwed on. The closing element could be integrated not directly on the battery housing but rather first into the hose. A filter element, in particular a fleece or a solid body fill, could be provided that binds or absorbs exiting gas and/or components. Activated carbon or drying agent could be used as absorption agents.

The material from which the sealing closing element is manufactured could be designed to screen electromagnetically. This would ensure that no currents can pass out of/into the battery housing. The screening can take place, for example, by mixing in electrically conductive fillers into an elastomer. Alternatively, it is conceivable to coat at least one surface of the closing element end of the nipple in an electrically conductive manner. This could take place by the vapor deposition of metal or by a galvanic separation. Due to the relatively low elastic movement/low expansion rates it should not be assumed that this coating bursts off during operation.

The surfaces of the connection groups, which surfaces face the metal, in particular the surfaces in the area of the opening, could be coated. This prevents a caking of the elastomer on the metallic surfaces, thus guaranteeing a reliable opening of the cover even after a long service life.

The flexible connection piece could be subsequently attached to one or both structural components, namely cover or nipple. This makes a modular construction possible.

A part of the nipple could be subsequently separated off. This could take place by theoretical breaking sites or by notching. This is advantageous for reducing the construction space.

A removal apparatus, for example a tube, a hose or the like could be attached above the closing element which apparatus can securely remove the gases released by the opening of the cover.

The cover should react at an excess inside pressure of 1 bar with an area of 10 cm². However, it must not react at an excess inside pressure of 0.3 bar with an area of 10 cm². The cover must not react or be destroyed at an outside pressure that is greater than the inside pressure.

The cover, connection piece, seal or nipple could be manufactured from elastomers. NBR (nitrile-butadiene rubber), HNBR(hydrogenated nitrile-butadiene rubber, (EPDM) ethylene-propylene-diene rubber, (FKM) fluorine rubber, (ACM) acrylate rubber, or (VMQ) silicon rubber can be used as elastomers.

Further areas of applicability will become apparent from the description provided herein. The description and specific examples in this summary are intended for purposes of illustration only and are not intended to limit the scope of the present disclosure.

### SHORT DESCRIPTION OF THE DRAWINGS

FIG. 1 schematically shows a battery housing that surrounds an inner chamber and has a temporary first opening, whereby a sealing closing element is arranged in the first opening;

FIG. 2 shows a perspective view and a sectional view of the sealing closing element, that consists of a cover with a circumferential seal, whereby the cover is connected by a flexible connection piece to a nipple;

FIG. 3 shows a sectional view of the sealing closing element, consisting of a cover with a circumferential seal, which cover is connected by a flexible connection piece to a nipple and is introduced in its entirety into the wall of the battery housing; and

FIG. 4 shows a sectional view of another exemplary embodiment of the sealing closing element, whereby an area of the cover encloses an obtuse angle with the wall of a battery housing.

Corresponding reference numerals indicate corresponding parts throughout the several views of the drawings.

### IMPLEMENTATION OF THE INVENTION

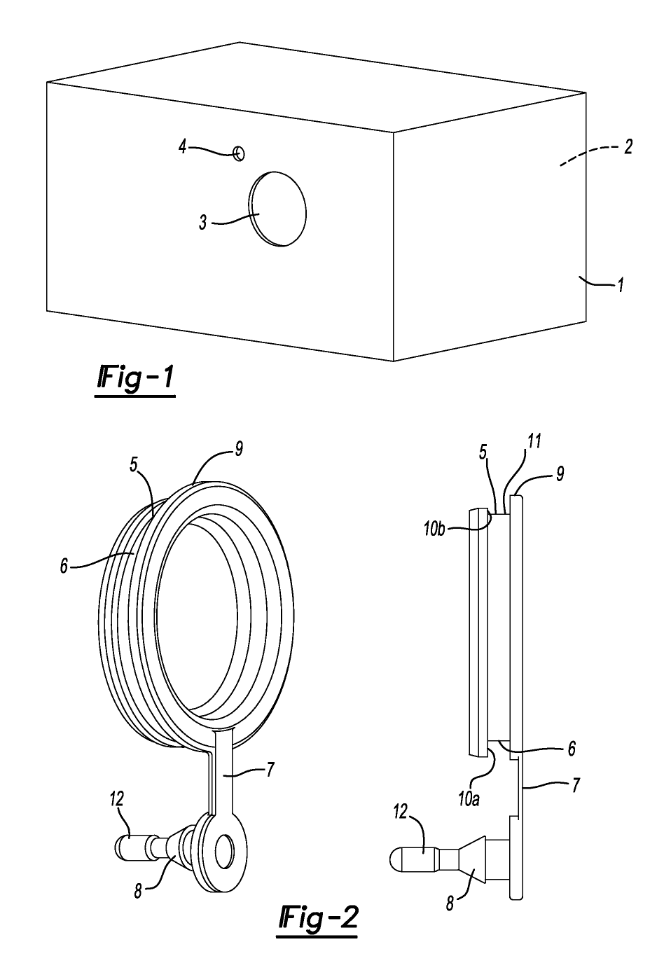

FIG. 1 schematically shows a battery housing 1 that surrounds an inner chamber 2 and has a temporary first opening 3. The first opening 3 is closed by the sealing closing element described in FIGS. 2 to 4. This closing element has a flexible connection piece that is connected to a nipple. The nipple is received in a temporary second opening 4.

FIG. 2 shows the closing element in a left and in a right view for closing the first opening 3 of a battery housing 1, comprising a cover 5, whereby cover 5 comprises a connection groove 6, into which a wall of a battery housing 1 can be snapped, whereby a connection piece 7 that can be deformed without being destroyed projects from cover 5, and whereby connection piece 7 is provided with a nipple 8.

Cover 5 comprises a circumferential seal 9 for resting on the outer wall of battery housing 1. Connection groove 6 forms different projections 10a, 10b on the side facing the inner wall of battery housing 1. A projection 10a that is closer to nipple 8 is larger than a projection 10b that is at a distance from nipple 8. Projection 10a extends further in the radial direction from groove bottom 11 than projection 10b does. Circumferential connection groove 6 is arranged eccentrically to circumferential seal 9.

Nipple 8 is provided with an assembly aid 12 that is set on it in a removable manner. Assembly aid 12 is constructed as a small cap.

FIG. 2 shows the sealing closing element in a left perspective view and in a right sectional view, consisting of a cover 5 with a circumferential seal 9 connected by a flexible connection piece 7 to nipple 8. Nipple 8 comprises a projecting and optionally removable assembly aid 12.

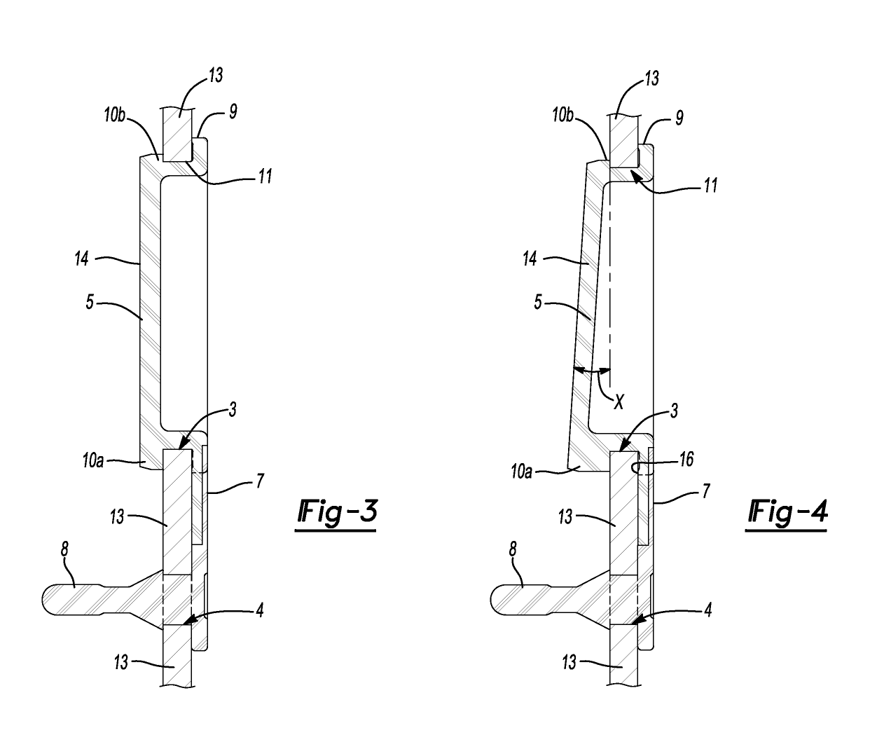

FIG. 3 shows a sectional view of the sealing closing element, consisting of a cover 5 with a circumferential seal 9 that is connected by a flexible connection piece 7 to nipple 8 and is introduced in its entirety into the wall 13 of a battery housing, 1. In this embodiment the area 14 of cover 5 is plane parallel to wall 13. The connection groove 6 has in this instance different projections 10a, 10b in such a manner that projection 10a on the side closer to nipple 8 is larger than projection 10b on the side opposite nipple 8. An eccentric construction is present here. This has the result that upon an inside excess pressure cover 5 opens first on the side opposite nipple 8 and thus a moderate pressure degradation takes place.

FIG. 4 shows a closing element in which an area 14 of cover 5 encloses an angle with a parallel plane to wall 13 of battery housing 1. Area 14 of cover 5 encloses an angle X in the range of 2°<X<30° with a plane parallel to the inner wall of the battery housing.

FIGS. 3 and 4 show a battery housing 1 with a first opening 3, whereby a cover 5 of a closing element is received in first opening 3 and whereby nipple 8 is received in a second opening 4.

FIG. 4 shows that a slot 15 is formed between the wall 13 in which the openings 3, 4 are formed and between a groove bottom 11 of cover 5.

FIG. 4 shows a sectional view of the sealing closing element, consisting of a cover 5 with a circumferential seal 9 that is connected by a flexible connection piece 7 to nipple 8 and is inserted in its entirety into wall 13 of a battery housing 1. In this embodiment the surface 14 of cover 5 encloses an angle X that is 2°<X<30° with inner wall 13 of the battery housing 1. The two connection grooves 6 have in this instance approximately equal projections 10a, 10b. This has the result that upon an inner excess pressure the cover 5 is unequally loaded at first and as a result opens at first on the side opposite nipple 8 and therefore a moderate pressure degradation takes place.

FIG. 4 shows a sectional view of a sealing closing element. The two connection grooves 6 are limited by seal 9, which has a lip 16 facing wall 13. Connection grooves 6 form a slot with battery housing 1. This embodiment has the following advantages: seal 9 prevents the penetration of water and compensates temperature fluctuations over broad areas. Slot 15 prevents a caking of the elastomer on battery housing 1. In addition, after a fairly long time a desired settling of the seal 9 occurs, so that the slot 15 retains its width or even becomes slightly larger. This ensures that a reliable opening of the first opening 3 can take place even after a long service life of the closing element.

In FIGS. 2 to 4 wall 13 of battery housing 1 has an inner wall and an outer wall. Projections 10a, 10b rest on the inner wall and seal 9 rests on the outer wall.

1. A closing element for closing an opening (3) of a battery housing (1), comprising a cover (5), whereby the cover (5) comprises a connection groove (6) into which groove a wall (13) of a battery housing (1) can be inserted, whereby a connection piece (7) that can be deformed without destruction projects from the cover (5) and whereby the connection piece (7) is provided with a nipple (8).

2. The closing element according to claim 1, characterized in that the cover (5) comprises a circumferential seal (9) for resting on the outer wall of the battery housing (1).

3. The closing element according to claim 1 or 2, characterized in that the connection groove (6) forms different projections (10a, 10b) on the side facing the inner wall of the battery housing (1).

4. The closing element according to claim 3, characterized in that a projection (10a) that is closer to the nipple (8) is larger than a projection (10b) that is at a distance from the nipple (8).

5. The closing element according to claim 1, characterized in that an area (14) of the cover (5) encloses an angle with a plane parallel to the inner wall of the battery housing (1).

6. The closing element according to claim 1, characterized in that an area (14) of the cover (5) encloses an angle X with a plane parallel to the inner wall of the battery housing (1) which angle X is in the range of 2°<X<30°.

7. The closing element according to claim 1, characterized in that the nipple (8) is provided with an assembly aid (12) that is set on it in such a manner that it can be removed.

8. A housing comprising:
a wall structure defining an enclosure with a first opening (3), and a second opening (4), whereby a cover (5) of a closing element is received in the first opening (3), whereby the cover (5) comprises a connection groove (6) into which groove a wall of said wall structure can be inserted, whereby a connection piece (7) projects from the cover (5) and is provided with a nipple (8), and whereby the nipple (8) is received in said second opening (4).

9. The housing according to claim 8, characterized in that a slot (15) is formed between the wall (13) in which the first opening (4) is formed and between a groove bottom (11) of the cover (5).

10. (canceled)
